(19) United States
(12) Patent Application Publication
(10) Pub. No.: US 2014/0145631 A1
(43) Pub. Date: May 29, 2014

(54) BACKLIGHT DRIVER CIRCUIT AND LIQUID CRYSTAL DISPLAY DEVICE

(71) Applicant: Fei Li, Shenzhen City (CN)

(72) Inventor: Fei Li, Shenzhen City (CN)

(73) Assignee: Shenzhen China Star Optoelectronics Technology Co. Ltd., Shenzhen, Guangdong (CN)

(21) Appl. No.: 13/809,912

(22) PCT Filed: Dec. 3, 2012
(86) PCT No.: PCT/CN12/85763

§ 371 Date: Jan. 14, 2013

(30) Foreign Application Priority Data
Nov. 28, 2012 (CN) 201210493971.5

(51) Int. Cl. H05B 33/08

(52) U.S. Cl. CPC H05B 33/0851
USPC 315/192

(57) ABSTRACT

The present invention provides a backlight driver circuit, which includes a plurality of LED strips connected in parallel, the input end of each of the LED strips being coupled to a DC power source; a detection module, coupled to the plurality of LED strips for detecting an output current of each LED strip; a reference current generation module, for providing a reference current; and an impedance adjustment module, based on a detection result of the detection module, through adjusting impedance, for adjusting the output current on each LED strip to the same level as the reference current generated by the reference current generation module. Correspondingly, the present invention provides a liquid crystal display device using the above backlight driver circuit. As such, present invention can maintain the current running through each LED strip at the same level and reduce the cost of backlight driver circuit.

The present application claims priority of “BACKLIGHT DRIVER CIRCUIT AND LIQUID CRYSTAL DISPLAY DEVICE”, application number 201210493971.5 submitted to State Intellectual Property Office, People Republic of China dated Nov. 28, 2012.

### BACKGROUND OF THE INVENTION

1. Field of the Invention

The present invention relates to the field of liquid crystal displaying techniques, and in particular to a backlight driver circuit and liquid crystal display device.

2. The Related Arts

In known liquid crystal displaying techniques, the LED driver circuit usually uses boost circuit (a boost converter or a step-up converter) to provide power to the LED.

As shown in FIG. 1, in the dashed box, inductor L1, LED D10, resistor R1 and MOS (MOS-TFT) transistor Q1 and some of the elements in the driver chip form a boost circuit to supply power to the LED with the driver chip.

Because of the boost circuit, the cost of backlight circuit increases. In addition, as the known LED backlight source usually comprises a plurality of LED light strips and different light strips may have different voltages, a more complicated circuit must be designed for the backlight source to keep the current running through each LED light strip to stay at a same level.

### SUMMARY OF THE INVENTION

The technical issue to be addressed by the present invention is to provide a backlight driver circuit and liquid crystal display device, to reduce the design complexity of the backlight driver circuit and reduce the cost of the backlight driver circuit so that maintaining the current running through each LED light strip at the same level becomes easier.

The present invention provides a backlight driver circuit, which comprises: a plurality of LED strips connected in parallel, the input end of each of the LED strips being coupled to a DC power source; a detection module, coupled to the plurality of LED strips for detecting an output current of each LED strip; a reference current generation module, for providing a reference current; and an impedance adjustment module, based on a detection result of the detection module, through adjusting impedance, for adjusting the output current on each LED strip to the same level as the reference current generated by the reference current generation module.

According to a preferred embodiment of the present invention, the reference current provided by the reference current generation module is configured in advance.

According to a preferred embodiment of the present invention, the impedance adjustment module comprises: a variable resistor connected in series with each LED strip; wherein through adjusting the variable resistor connected in series to each LED strip, the impedance adjustment module adjusts the output current of the LED strip to the level of reference current.

According to a preferred embodiment of the present invention, the reference current generation module is coupled to the LED strip having the most voltage drop among the plurality of LET strips, wherein the reference current is the output current of the LED strip having the most voltage drop.

According to a preferred embodiment of the present invention, the impedance adjustment module comprises: a variable resistor connected in series with each LED strip except the LED strip having the most voltage drop; wherein through adjusting the variable resistor connected in series to each LED strip, the impedance adjustment module adjusts the output current of each LED strip to the level of reference current, except the LED strip having the most voltage drop.

Correspondingly, the present invention provides a backlight driver circuit, which comprises: a plurality of LED strips connected in parallel, the input end of each of the LED strips being coupled to a DC power source; a detection module, coupled to the plurality of LED strips for detecting an output current of each LED strip; a reference current generation module, coupled to an LED strip having the most voltage drop among the plurality of LED strips and using the output current of the LED strip having the most voltage drop as a reference current; and an impedance adjustment module, based on a detection result of the detection module, through adjusting impedance, for adjusting the output current on each LED strip to the same level as the reference current generated by the reference current generation module.

According to a preferred embodiment of the present invention, the impedance adjustment module comprises: a variable resistor connected in series with each LED strip except the LED strip having the most voltage drop; wherein through adjusting the variable resistor connected in series to each LED strip, the impedance adjustment module adjusts the output current of each LED strip to the level of reference current, except the LED strip having the most voltage drop.

The present invention provides a liquid crystal display device, which comprises a backlight driver circuit, the backlight driver circuit further comprising: a plurality of LED strips connected in parallel, the input end of each of the LED strips being coupled to a DC power source; a detection module, coupled to the plurality of LED strips for detecting an output current of each LED strip; a reference current generation module, for providing a reference current; and an impedance adjustment module, based on a detection result of the detection module, through adjusting impedance, for adjusting the output current on each LED strip to the same level as the reference current generated by the reference current generation module.

According to a preferred embodiment of the present invention, the reference current provided by the reference current generation module is configured in advance.

According to a preferred embodiment of the present invention, the impedance adjustment module comprises: a variable resistor connected in series with each LED strip; wherein through adjusting the variable resistor connected in series to each LED strip, the impedance adjustment module adjusts the output current of the LED strip to the level of reference current.

According to a preferred embodiment of the present invention, the reference current generation module is coupled to the LED strip having the most voltage drop among the plurality of LET strips, wherein the reference current is the output current of the LED strip having the most voltage drop.

According to a preferred embodiment of the present invention, the impedance adjustment module comprises: a variable resistor connected in series with each LED strip except the LED strip having the most voltage drop; wherein through adjusting the variable resistor connected in series to each LED strip, the impedance adjustment module adjusts the output current of each LED strip to the level of reference current, except the LED strip having the most voltage drop.

The efficacy of the present invention is that to be distinguished from the state of the art. Through disposing the impedance adjustment module to connect a variable resistor in series with each LED strip, the present invention can adjust the variable resistor to so that the current running through each LED strip can be adjusted to a fixed level. As such, the current running through each LED strip can be maintained at the same level. In addition, the present invention can reduce the design complexity of backlight driver circuit and reduce the cost of backlight driver circuit.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known backlight driver circuit;

FIG. 2 is a schematic view showing the structure of an embodiment of a backlight driver circuit according to the present invention; and

FIG. 3 is a schematic view showing the structure of another embodiment of a backlight driver circuit according to the present invention.

### DETAILED DESCRIPTION OF THE PREFERRED EMBODIMENTS

The following refers to drawing to describe the preferred embodiments of the present invention.

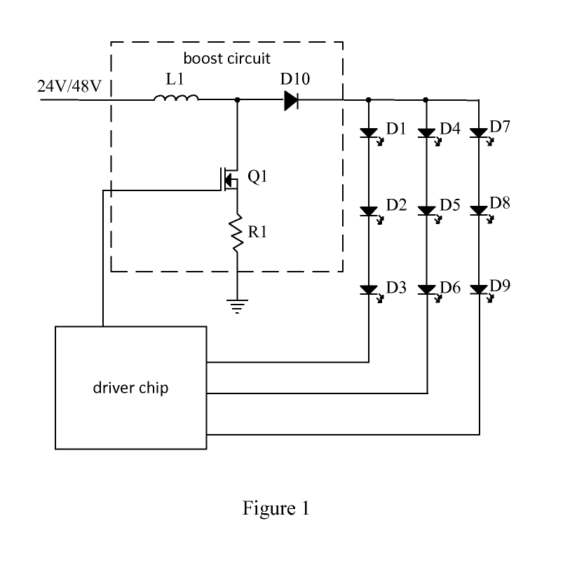

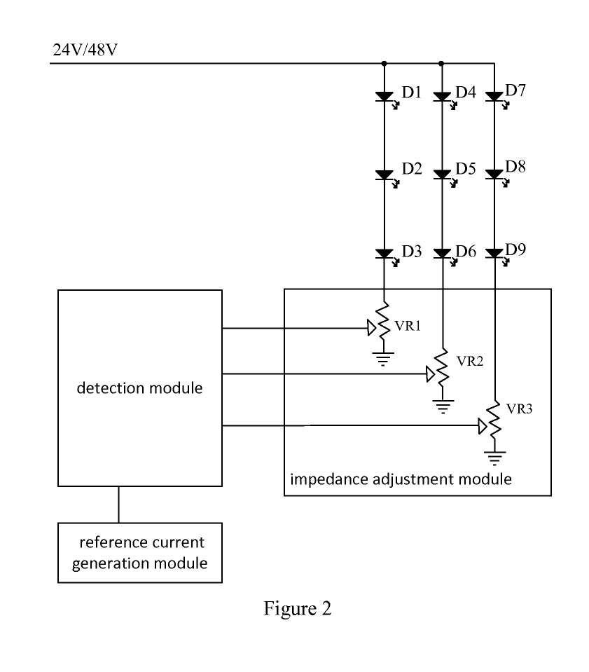

The present invention provides a backlight driver circuit, as show in FIG. 2. The backlight driver circuit comprises: a plurality of LED strips connected in parallel, the input end of each of the LED strips being coupled to a DC power source. Three LED strips are shown in FIG. 1, wherein D1-D3 form the first LED strip, D4-D6 form the second LED strip and D7-D9 form the third LED strip. It should be understood that the number of LED strip and the number of LEDs in each LED strip are only exemplary. The input ends of the three LED strips are coupled to a DC power source, such as 24V or 48V;

A detection module, coupled to the plurality of LED strips for detecting an output current of each LED strip;

A reference current generation module, for providing a reference current, the reference current can be configured in advance, such as, through an adjustable reference voltage module to provide; and

An impedance adjustment module, based on a detection result of the detection module, through adjusting impedance, for adjusting the output current on each LED strip to the same level as the reference current generated by the reference current generation module. Specifically, the impedance adjustment module comprises: a variable resistor connected in series with each LED strip; for example, the variable resistor VR1 connected to the first LED strip, the variable resistor VR2 connected to the second LED strip, the variable resistor VR3 connected to the third LED strip; wherein the adjustable terminal of each variable resistor is coupled to the detection module, and the other terminal is grounded; wherein through adjusting the variable resistor connected in series to each LED strip, the impedance adjustment module can change the resistance connected to each LED strip so as to adjust the output current of the LED strip to the level of reference current.

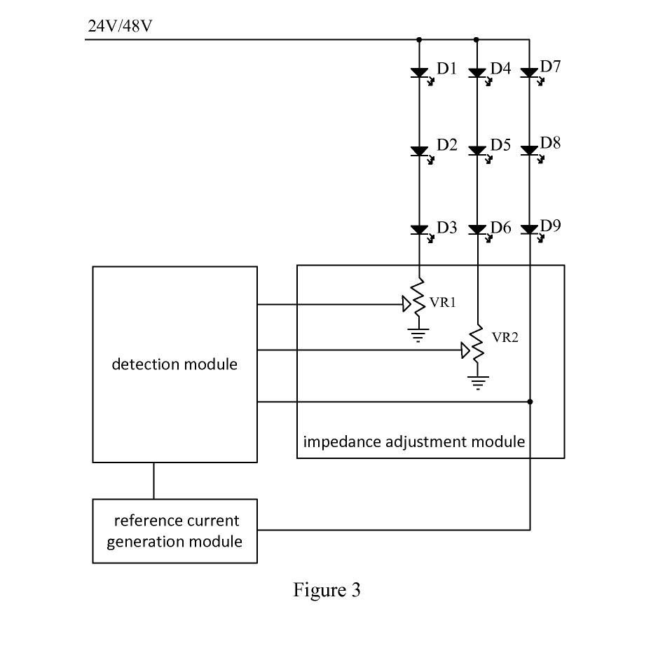

FIG. 3 is a schematic view showing the structure of another embodiment of a backlight driver circuit according to the present invention. As shown in FIG. 3, the backlight driver circuit comprises: a plurality of LED strips connected in parallel, the input end of each of the LED strips being coupled to a DC power source. Three LED strips are shown in FIG. 1, wherein D1-D3 form the first LED strip, D4-D6 form the second LED strip and D7-D9 form the third LED strip. It should be understood that the number of LED strip and the number of LEDs in each LED strip are only exemplary. The input ends of the three LED strips are coupled to a DC power source, such as 24V or 48V;

A detection module, coupled to the plurality of LED strips for detecting an output current of each LED strip;

A reference current generation module, for providing a reference current, coupled to an LED strip having the most voltage drop among the plurality of LED strips, for example, the third LED strip in FIG. 3 having the most voltage drop, the reference current generated by the reference current generation module being the output current of the LED strip (the third LED strip) having the most voltage drop; and

An impedance adjustment module, based on a detection result of the detection module, through adjusting impedance, for adjusting the output current on each LED strip to the same level as the reference current generated by the reference current generation module. Specifically, the impedance adjustment module comprises: a variable resistor connected in series with each LED strip except the LED strip having the most voltage drop; for example, the variable resistor VR1 connected to the first LED strip, the variable resistor VR2 connected to the second LED strip; wherein the adjustable terminal of each variable resistor is coupled to the detection module, and the other terminal is grounded; wherein through adjusting the variable resistor connected in series to each LED strip, the impedance adjustment module can change the resistance connected to each LED strip so as to adjust the output current of the first LED strip and the second LED strip to the level of reference current so that the first LED strip and the second LED strip will have the same output current as the third LED strip.

Correspondingly, the present invention provides a liquid crystal display device, which comprises a backlight driver circuit as shown in FIG. 2 or FIG. 3. The specific details can refer to the description of FIG. 2 and FIG. 3.

The efficacy of the present invention is that to be distinguished from the state of the art. Through disposing the impedance adjustment module to connect a variable resistor in series with each LED strip (or a plurality of LED strips), the present invention can adjust the variable resistor to so that the current running through each LED strip can be adjusted to a fixed level. As such, the current running through each LED strip can be maintained at the same level. In addition, the present invention can reduce the design complexity of backlight driver circuit and reduce the cost of backlight driver circuit.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight driver circuit, which comprises:
a plurality of LED strips connected in parallel, the input end of each of the LED strips being coupled to a DC power source;
a detection module, coupled to the plurality of LED strips for detecting an output current of each LED strip;
a reference current generation module, for providing a reference current; and
an impedance adjustment module, based on a detection result of the detection module, through adjusting impedance, for adjusting the output current on each LED strip to the same level as the reference current generated by the reference current generation module.

2. The backlight driver circuit as claimed in claim 1, characterized in that the reference current provided by the reference current generation module is configured in advance.

3. The backlight driver circuit as claimed in claim 1, characterized in that the impedance adjustment module comprises: a variable resistor connected in series with each LED strip;
wherein through adjusting the variable resistor connected in series to each LED strip, the impedance adjustment module adjusts the output current of the LED strip to the level of reference current.

4. The backlight driver circuit as claimed in claim 2, characterized in that the impedance adjustment module comprises: a variable resistor connected in series with each LED strip;
wherein through adjusting the variable resistor connected in series to each LED strip, the impedance adjustment module adjusts the output current of the LED strip to the level of reference current.

5. The backlight driver circuit as claimed in claim 1, characterized in that the reference current generation module is coupled to the LED strip having the most voltage drop among the plurality of LET strips, wherein the reference current is the output current of the LED strip having the most voltage drop.

6. The backlight driver circuit as claimed in claim 5, characterized in that the impedance adjustment module comprises: a variable resistor connected in series with each LED strip except the LED strip having the most voltage drop;
wherein through adjusting the variable resistor connected in series to each LED strip, the impedance adjustment module adjusts the output current of each LED strip to the level of reference current, except the LED strip having the most voltage drop.

7. A backlight driver circuit, which comprises:
a plurality of LED strips connected in parallel, the input end of each of the LED strips being coupled to a DC power source;
a detection module, coupled to the plurality of LED strips for detecting an output current of each LED strip;
a reference current generation module, coupled to an LED strip having the most voltage drop among the plurality of LED strips and using the output current of the LED strip having the most voltage drop as a reference current; and
an impedance adjustment module, based on a detection result of the detection module, through adjusting impedance, for adjusting the output current on each LED strip to the same level as the reference current generated by the reference current generation module.

8. The backlight driver circuit as claimed in claim 7, characterized in that the impedance adjustment module comprises: a variable resistor connected in series with each LED strip except the LED strip having the most voltage drop;
wherein through adjusting the variable resistor connected in series to each LED strip, the impedance adjustment module adjusts the output current of each LED strip to the level of reference current, except the LED strip having the most voltage drop.

9. A liquid crystal display device, which comprises a backlight driver circuit, the backlight driver circuit further comprising:
a plurality of LED strips connected in parallel, the input end of each of the LED strips being coupled to a DC power source;
a detection module, coupled to the plurality of LED strips for detecting an output current of each LED strip;
a reference current generation module, for providing a reference current; and
an impedance adjustment module, based on a detection result of the detection module, through adjusting impedance, for adjusting the output current on each LED strip to the same level as the reference current generated by the reference current generation module.

10. The liquid crystal display device as claimed in claim 9, characterized in that the reference current provided by the reference current generation module is configured in advance.

11. The liquid crystal display device as claimed in claim 9, characterized in that the impedance adjustment module comprises: a variable resistor connected in series with each LED strip;
wherein through adjusting the variable resistor connected in series to each LED strip, the impedance adjustment module adjusts the output current of the LED strip to the level of reference current.

12. The liquid crystal display device as claimed in claim 10, characterized in that the impedance adjustment module comprises: a variable resistor connected in series with each LED strip;
wherein through adjusting the variable resistor connected in series to each LED strip, the impedance adjustment module adjusts the output current of the LED strip to the level of reference current.

13. The liquid crystal display device as claimed in claim 9, characterized in that the reference current generation module is coupled to the LED strip having the most voltage drop among the plurality of LET strips, wherein the reference current is the output current of the LED strip having the most voltage drop.

14. The liquid crystal display device as claimed in claim 13, characterized in that the impedance adjustment module comprises: a variable resistor connected in series with each LED strip except the LED strip having the most voltage drop;
wherein through adjusting the variable resistor connected in series to each LED strip, the impedance adjustment module adjusts the output current of each LED strip to the level of reference current, except the LED strip having the most voltage drop.
